(19) United States
(12) Patent Application Publication
(10) Pub. No.: US 2026/0021508 A1
(43) Pub. Date: Jan. 22, 2026

(54) AUTOMATED CUP DECORATOR AND ASSOCIATED SYSTEMS, DEVICES, AND METHODS

(71) Applicant: BOTRISTA, INC., San Francisco, CA (US)

(72) Inventors: Wu-Chou KUO, San Francisco, CA (US); Yu-Wei CHEN, New Taipei City (TW)

(21) Appl. No.: 18/778,838

(22) Filed: Jul. 19, 2024

(51) Int. Cl. B05C 7/02; B05C 11/10

(52) U.S. Cl. CPC B05C 7/02; B05C 11/1002

(57) ABSTRACT

Systems, devices, and methods for decorating cups are described herein. Embodiments of the present disclosure include a cup decoration system including an ingredient container and a cup decorating device. The cup decoration device can include a nozzle, a pump, a motor, and a controller. The nozzle can be coupled to receive ingredients, include an outlet, and be configured to be positioned adjacent to or partially inside a cup to be decorated. The pump can be coupled to drive the ingredients through the outlet of the nozzle. The motor can be coupled to rotate the nozzle relative to the cup. The controller can be operably coupled to the pump and the motor, and be configured to operate the pump and the motor such that the nozzle dispenses the ingredients onto an inner surface of the cup via the outlet to create a layer having a predetermined pattern.

### TECHNICAL FIELD

The present disclosure relates generally to automated cup decorators and associated systems, devices, and methods.

### BACKGROUND

For many consumers, freshly made beverages are more attractive than factory-produced canned or bottled beverages for various reasons including freshness, taste, and flexibility of customizing ingredient combinations. Therefore, many restaurants and beverage vendors offer a variety of freshly made beverages to meet the needs of their customers. As a result of rising labor costs and other factors (e.g., increased operating costs due to impacts of the pandemic or inflation), many restaurants and beverage vendors have begun to use a variety of machinery and equipment to provide or assist in the preparation of freshly-made beverages in order to reduce the required labor time and costs. Decorating cups is an additional service that is also in demand, as decorated cups can provide improved visual aesthetics to consumers. However, decorating cups can be a labor-intensive and time-consuming task, and restaurants and beverage vendors continue to rely on employees to decorate drinks, such as by manually squeezing ingredients from a bottle onto the inner surface of cups. Also, depending on the decoration pattern or design, a certain level of skill can be required, necessitating training, another time-consuming and expensive process. Therefore, there is a need for solutions that can automate the decoration of cups.

### BRIEF DESCRIPTION OF THE DRAWINGS

Features, aspects, and advantages of the presently disclosed technology may be better understood with regard to the following drawings.

FIG. 1 is a schematic block diagram of a cup decoration system configured in accordance with embodiments of the present technology.

FIG. 2 is a partially schematic illustration of a cup decoration system configured in accordance with embodiments of the present technology.

FIGS. 3A-3D illustrate a series of operation steps of the cup decoration system of FIG. 2.

FIG. 4 is a partially schematic illustration of another cup decoration system configured in accordance with embodiments of the present technology.

FIGS. 5A-5C illustrate a series of operation steps of another cup decoration system configured in accordance with embodiments of the present technology.

FIGS. 6A-6C illustrate a series of operation steps of another cup decoration system configured in accordance with embodiments of the present technology.

FIGS. 7A and 7B illustrate a series of operation steps of another cup decoration system configured in accordance with embodiments of the present technology.

FIG. 8 is a partially schematic illustration of an electronics bay of the cup decoration system of FIG. 7A.

FIGS. 9A and 9B illustrate a series of operation steps of another cup decoration system configured in accordance with embodiments of the present technology.

FIG. 10 is a partially schematic illustration of a nozzle moving assembly configured in accordance with embodiments of the present technology.

FIG. 11 is a partially schematic illustration of another nozzle moving assembly configured in accordance with embodiments of the present technology.

FIGS. 12A and 12B illustrate a series of operation steps of another cup decoration system configured in accordance with embodiments of the present technology.

FIG. 13 is a partially schematic illustration of another cup decoration system configured in accordance with embodiments of the present technology.

FIG. 14 is a top, cutaway view of the cup decoration system of FIG. 13.

FIGS. 15A-15C illustrate a series of operation steps of the cup decoration system of FIG. 13.

FIGS. 16A-16C schematically illustrate a series of operation steps in accordance with embodiments of the present technology.

FIGS. 17-22 illustrate various cup decoration patterns that can be produced by systems configured in accordance with embodiments of the present technology.

FIG. 23 schematically illustrates another cup decoration system configured in accordance with embodiments of the present technology.

FIG. 24 schematically illustrates another cup decoration system configured in accordance with embodiments of the present technology.

FIG. 25 schematically illustrates another cup decoration system configured in accordance with embodiments of the present technology.

FIG. 26 schematically illustrates another cup decoration system configured in accordance with embodiments of the present technology.

FIG. 27 is a flowchart illustrating a method for decorating a cup in accordance with embodiments of the present technology.

FIG. 28 is a block diagram illustrating an overview of devices on which some implementations can operate.

FIG. 29 is a block diagram illustrating an overview of an environment in which some implementations can operate.

FIG. 30 is a block diagram illustrating components which, in some implementations, can be used in a system employing the disclosed technology.

A person skilled in the relevant art will understand that the features shown in the drawings are for purposes of illustrations, and variations, including different and/or additional features and arrangements thereof, are possible.

### DETAILED DESCRIPTION

### A. Overview

Embodiments of the present technology are directed to systems, devices, and methods for decorating cups. Decorated cups can increase the value of beverages to consumers by providing a more aesthetic appearance. Also, decorating the inside of cups with edible ingredients can improve both the aesthetic appearance and the flavor of drinks. For example, various syrups can be applied to the inner surface of a cup in a pattern. However, decorating cups today requires employees and staff members to manually apply ingredients onto cups, making decorating cups a labor-intensive and time-consuming process. Moreover, creating patterns can require a certain level of decorating skills, requiring training and/or talent while remaining subject to human error.

Embodiments of the present technology address at least some of the above described issues for decorating cups. For example, embodiments of the present disclosure include a cup decoration system including an ingredient container and a cup decorating device coupled to receive ingredients from the ingredient container. The cup decoration device can include a nozzle, a pump, a motor, and a controller. The nozzle can be coupled to receive ingredients, include an outlet, and be configured to be positioned above a cup to be decorated. The pump can be coupled to drive the ingredients through the outlet of the nozzle. The motor can be coupled to rotate the nozzle relative to the cup. The controller can be operably coupled to the pump and the motor, and be configured to operate the pump and the motor such that the nozzle dispenses the ingredients onto an inner surface of the cup via the outlet to create a layer having a predetermined pattern.

In some embodiments, a cup decoration device includes a nozzle, a pump, a motor, and a controller. The nozzle can be coupled to receive ingredients, include an outlet, and be configured to be positioned above the cup. The pump can be coupled to drive the ingredients through the outlet of the nozzle. The motor can be coupled to rotate the cup relative to the nozzle. The controller can be operably coupled to the pump and the motor, and be configured to operate the pump and the motor such that the nozzle dispenses the ingredients onto an inner surface of the cup via the outlet to create a layer having a predetermined pattern.

In some embodiments, a method of decorating a cup includes providing a nozzle configured to be positioned above a cup, driving ingredients through an outlet of the nozzle, and moving one of the nozzle or the cup relative to the other such that the nozzle dispenses the ingredients onto an inner surface of the cup via the outlet to create a layer having a predetermined pattern.

Embodiments of the present technology improve the cup decorating process for both beverage vendors and consumers. For vendors, the cup decorating process is handled by devices as opposed to employees and staff members, thus decreasing labor and training needs. For consumers, the cup decorating process is expected to be faster and more precise than if performed by a person, thus decreasing waiting times and improving the overall consumer experience of enjoying a beverage in an aesthetically pleasing cup.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### B. Embodiments of Cup Decoration Systems

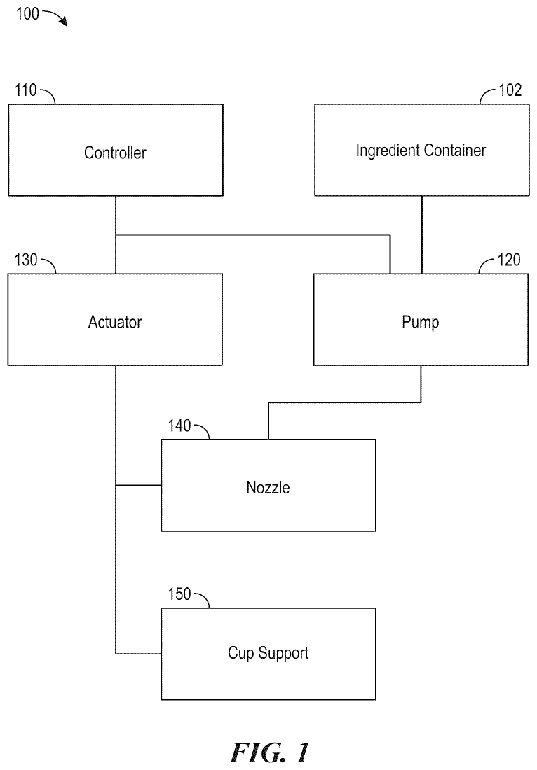

FIG. 1 is a schematic block diagram of a cup decoration system 100 (“the system 100”) configured in accordance with embodiments of the present technology. The system 100 can include an ingredient container 102, a controller 110, a pump 120, an actuator 130, a nozzle 140, and a cup support 150. As discussed further herein, the system 100 can be operated to decorate a cup, such as by applying one or more layers of ingredients on an inner surface of the cup. In FIG. 1, some of the components are linked together by lines, indicating that those components can be operably coupled to one another. However, in some embodiments, those components may not be operably coupled as such.

The ingredient container 102 can include a tank, a container, or other storage component for storing one or more ingredients to be used for decorating a cup. Example ingredients include, but are not limited to, syrups (e.g., caramel syrup, mocha syrup), whipped cream, and other fluid-based ingredients. In some embodiments, the ingredient container includes multiple, isolated compartments for separately storing multiple ingredients.

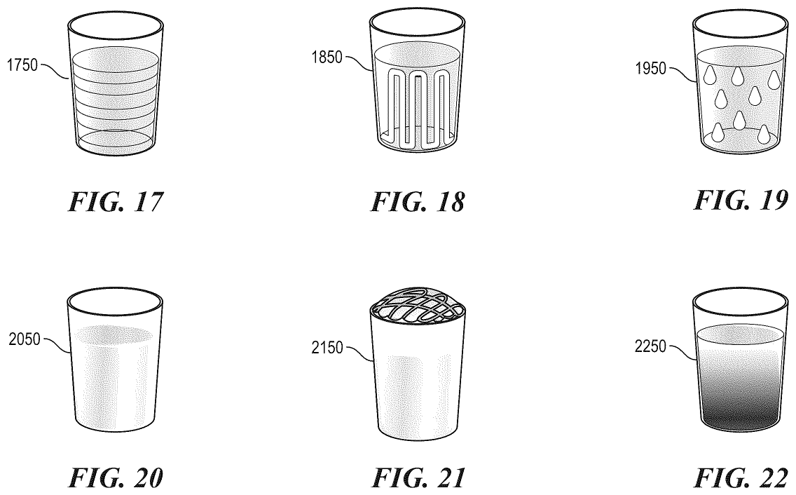

The controller 110 includes one or more hardware and software components for controlling operation of the system 100. For example, the controller 110 can include one or more processors (e.g., CPU(s), GPU(s), HPU(s), etc.) and memory (e.g., volatile storage, non-volatile storage) for storing instructions to be executed by the one or more processors. The controller 110 can receive input signals from a user (e.g., a consumer, a beverage vendor) and send control signals to the pump 120 and/or the actuator 130 based on the received input signals. Additionally or alternatively, the controller 110 can automatically send control signals to the pump 120 and/or the actuator 130 based on an algorithm (e.g., a recipe, a selected cup decoration pattern, a predetermined beverage production schedule, an algorithm that predicts demand). The memory can store one or more predetermined cup decoration patterns, examples of which are illustrated in FIGS. 17-22 In some embodiments, the controller 110 can identify and notify users of any inconsistencies between the recipe of the beverage and a cup decoration pattern selected or specified. In some embodiments, the controller 110 can identify insufficient quantities of one or more ingredients in the ingredient container 102, and notify users of the same and that certain cup decoration patterns are therefore unavailable.

The pump 120 can be operably coupled to the controller 110, and between the ingredient container 102 and the nozzle 140. The pump 120 can be operated to pump or otherwise drive the transfer of the ingredients from the ingredient container 102 to the nozzle 140. In some embodiments, the controller 110 can control the pump 120 to deliver specific or variable flow rates and/or quantities of the ingredients. The pressure provided by the pump 120 can vary depending on, for example, the viscosity of the ingredient. The controller 110 can also control the pump 120 to deliver the ingredients intermittently (e.g., with pauses in between) depending on the desired cup decoration pattern.

The actuator 130 can be operably coupled to the controller 110, the nozzle 140, and/or the cup support 150. The actuator 130 can include one or more motors, linear actuators, and/or other mechanical components for moving the nozzle 140 and/or the cup support 150 such that the ingredients can be dispensed from the nozzle 140 onto the cup (e.g., the inner surface thereof) in a desired cup decoration pattern.

The nozzle 140 can receive the ingredients pumped (e.g., by the pump 120) from the ingredient container 102 and dispense the ingredients onto the cup. As discussed above, the nozzle 140 can be moved (e.g., translated along and/or rotated about one or more axes) by the actuator 130. As discussed further herein, the nozzle 140 can include various geometries suitable for different ingredients, cup decoration patterns, processes, etc.

The cup support 150 can lift, suspend, hold, or otherwise support the cup to be decorated by the system 100. For example, the cup support 150 can include a platform, grippers, suction cups, etc. As discussed above, the cup support 150 can be moved (e.g., translated along and/or rotated about one or more axes) by the actuator 130.

In some embodiments, the actuator 130 is coupled to only one of the nozzle 140 or the cup support 150. For example, the actuator 130 can be coupled to move the nozzle 140 while the cup support 150 holds the cup stationary to create the desired cup decoration pattern. In another example, the actuator 130 can be coupled to move the cup support 150 (and thus the cup) while the nozzle 140 remains stationary while dispensing the ingredients to create the desired cup decoration pattern. Moreover, in some embodiments, the system 100 omits one or more of the components described above. For example, the system 100 may not include a cup support 150 and instead operate while the cup is placed on a nearby surface (e.g., a table).

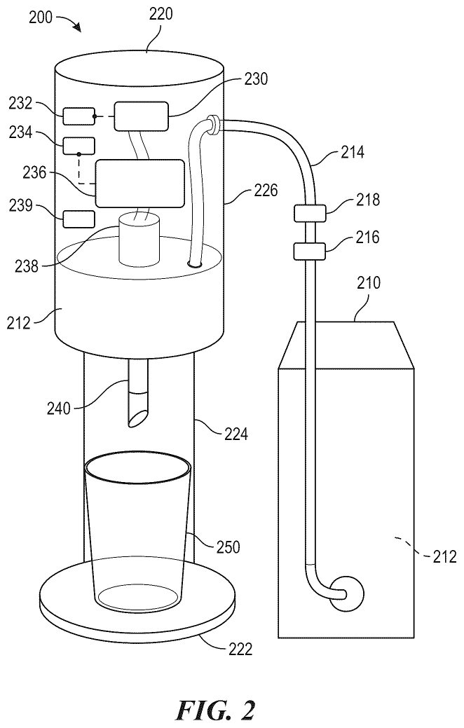

FIG. 2 is a partially schematic illustration of a cup decoration system 200 (“the system 200”) configured in accordance with embodiments of the present technology. The system 200 can include an ingredient container 210 (e.g., the ingredient container 102) and a cup decoration device 220 coupled to the ingredient container 210 via a tube 214. As discussed further herein, the cup decoration device 220 can decorate a cup 250 using ingredients 212 stored in the ingredient container 210.

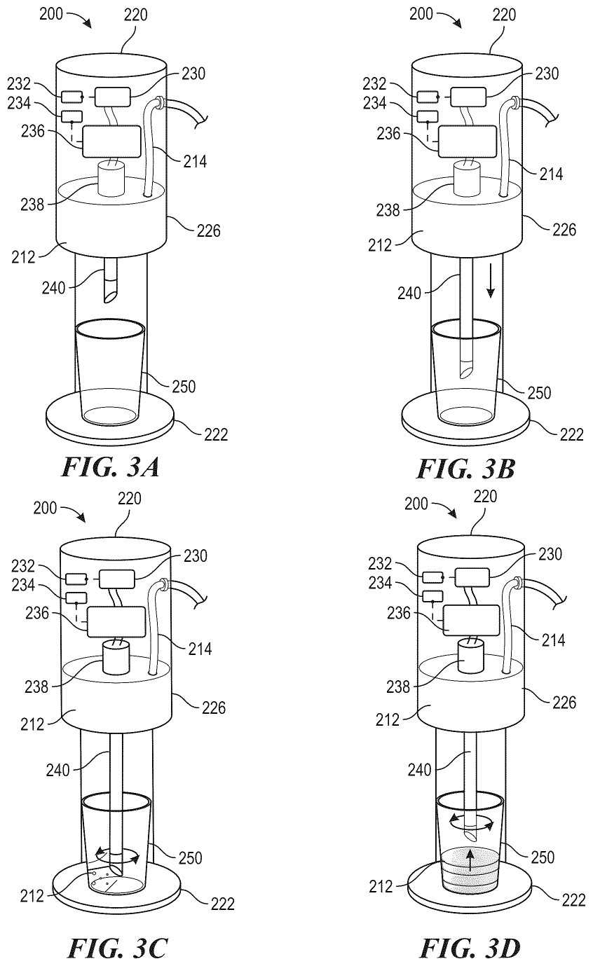

The system 200 can further include a liquid pump 216 and a valve 218 (e.g., a check valve) coupled to the tube 214 or otherwise operably coupled to the ingredient container 210. As discussed in further detail below with reference to FIGS. 3A-3D, the liquid pump 216 can pump the ingredients 212 stored in the ingredient container 210 to the cup decoration device 220 via the tube 214. In some embodiments, the valve 218 can be positioned to prevent backflow of the ingredients 212 in the tube 214.

The cup decoration device 220 can include a cup support 222 (e.g., the cup support 150), a housing 226, and a stem 224 extending therebetween. In the illustrated embodiment, the cup support 222 comprises a circular base or platform on which the cup 250 can be placed. The stem 224 extends upward from a perimeter of the cup support 222 to support the housing 226 above the cup 250. The interior of the housing 226 can receive the ingredients 212 via the tube 214 coupled to the ingredient container 210.

The cup decoration device 220 can further include an air pump 230 (e.g., the pump 120), a first controller 232, a second controller 234, an actuator 236 (e.g., the actuator 130), a motor 238, and a nozzle 240. The nozzle 240 comprises an elongate, straight, cylindrical shaft that can extend downward from the housing 226 towards the cup 250, as shown. The first controller 232 can be operably coupled to control the air pump 230 and the second controller 234 can be operably coupled to control the actuator 236 and/or the motor 238. In some embodiments, a single controller is used to control the pump 230, the actuator 236, and the motor 238. In some embodiments, three or more controllers are used to control the air pump 230, the actuator 236, and the motor 238. In some embodiments, the cup decoration device 220 additionally includes a heating element 239 positioned to heat the ingredients 212 pooled in the housing 226 and/or delivered through the nozzle 240. Heating the ingredients 212 can decrease the viscosity of the ingredients 212 and thereby allow the ingredients 212 to flow more smoothly through and out of the nozzle 240.

While FIG. 2 schematically illustrates the air pump 230, the first controller 232, the second controller 234, the actuator 236, and the motor 238 as positioned within the housing 226, one of ordinary skill in the art will appreciate that one or more of these components can be positioned outside of the housing 226. Also, while not illustrated, the components of the system 200 can receive power (e.g., electrical power) from a power outlet and/or a battery. Operation of the system 200 is described in further detail below with reference to FIGS. 3A-3D.

FIGS. 3A-3D illustrate a series of operation steps of the system 200. Referring first to FIG. 3A, the nozzle 240 is in a retracted state such that the cup 250 can be easily placed on the cup support 222 and the nozzle 240 is positioned above the cup 250. Also, the ingredients 212 pumped from the ingredient container 210 (not shown in FIGS. 3A-3D) by the liquid pump 216 and through the tube 214 are pooled in the housing 226 and the nozzle 240 can be in fluid communication with the pooled ingredients 212. In some embodiments, the air pump 230, the first controller 232, the second controller 234, the actuator 236, and/or the motor 238 are kept isolated from the pooled ingredients 212, such as via coverings or an internal container that houses the aforementioned components.

Referring next to FIG. 3B, the second controller 234 can operate the actuator 236 (e.g., a linear actuator) to lower the nozzle 240 to an extended state. Specifically, the actuator 236 can lower the nozzle 240 such that the nozzle 240 extends downward from the housing 226 and at least partially into the cup 250. The distance by which the actuator 236 lowers the nozzle 240 can be controlled depending on, for example, the desired cup decoration pattern and/or the shape of the nozzle 240.

Referring next to FIG. 3C, the first controller 232 can operate the air pump 230 to provide a static air pressure within the housing 226 and thereby drive the ingredients 212 out through the nozzle 240. In some embodiments, the air pump 230 comprises an air pump that can pressurize the space inside the housing 226 and above the pooled ingredients 212 therein (e.g., space filled with air), and the resulting pressure can push the pooled ingredients 212 into and through the nozzle 240. Depending on factors such as the viscosity of the ingredients 212, the shape of the nozzle 240, and the pressure applied by the air pump 230, the ingredients 212 can be driven through an outlet of the nozzle 240 in a spray pattern, in a stream or jet, in an oozing manner, etc. In some embodiments, the air pump 230 comprises a stable or constant pressure pump. In the illustrated embodiment, the distal end portion of the nozzle 240 is slanted such that the outlet of the nozzle 240 generally faces an inner sidewall surface of the cup 250. Furthermore, the motor 238 can be operated (e.g., via the second controller 234) to rotate the nozzle 240 about a longitudinal axis of the nozzle 240 (e.g., a vertical axis extending through the nozzle 240). Therefore, the outlet of the nozzle 240, which may face one direction at any given time, can be rotated such that the ingredients 212 can be applied around the inner surface of the cup 250 to form the desired cup decoration pattern.

Referring next to FIG. 3D, the actuator 236 can raise the nozzle 240 back to the retracted state. The ingredients 212 can continue to be pumped through the nozzle 240 as the outlet of the nozzle 240 moves upward such that the ingredients 212 can be applied to different heights of the inner surface of the cup 250. In some embodiments, the actuator 236 and the motor 238 can operate together such that the nozzle 240 is moved between the retracted and extended states and rotated simultaneously. Thus, by controlling the air pump 230, the actuator 236, and/or the motor 238, the system 200 can apply a desired cup decoration pattern onto the inner surface of the cup 250.

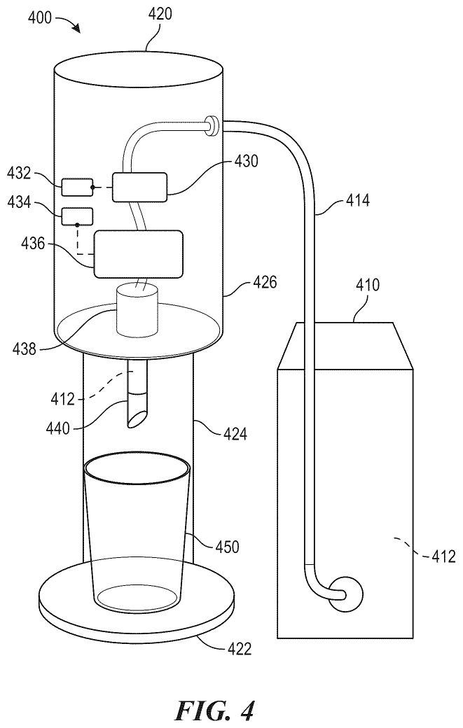

FIG. 4 is a partially schematic illustration of another cup decoration system 400 (“the system 400”) configured in accordance with embodiments of the present technology. Like the system 200, the system 400 can include an ingredient container 410 and a cup decoration device 420 coupled to the ingredient container 410 via a tube 414. The cup decoration device 420 can include a cup support 422, a housing 426, and a stem 424 extending therebetween. In the illustrated embodiment, the cup support 422 comprises a circular base or platform on which a cup 450 can be placed. The stem 424 extends upward from a perimeter of the cup support 422 to support the housing 426 above the cup 450.

The cup decoration device 420 can further include a liquid pump 430, a first controller 432, a second controller 434, an actuator 436, a motor 438, and a nozzle 440. The nozzle 440 comprises an elongate, straight, cylindrical shaft that can receive the ingredients 412 via the tube 414 coupled to the ingredient container 410, and can extend downward from the housing 426 towards the cup 450, as shown. The first controller 432 can be operably coupled to control the liquid pump 430 and the second controller 434 can be operably coupled to control the actuator 436 and/or the motor 438. In some embodiments, a single controller is used to control the liquid pump 430, the actuator 436, and the motor 438. In some embodiments, three or more controllers are used to control the liquid pump 430, the actuator 436, and the motor 438. While FIG. 4 schematically illustrates the liquid pump 430, the first controller 432, the second controller 434, the actuator 436, and the motor 438 as positioned within the housing 426, one of ordinary skill in the art will appreciate that one or more of these components can be positioned outside of the housing 426. Also, while not illustrated, the components of the system 400 can receive power (e.g., electrical power) from a power outlet and/or a battery.

In operation of the system 400, like in operation of the system 200 as discussed above with reference to FIGS. 3A-3D, the nozzle 440 can dispense or otherwise apply the ingredients 412 from the ingredient container 410 onto an inner surface of the cup 450. The actuator 436 and the motor 438 can translate and rotate the nozzle 440, respectively, to create a desired cup decoration pattern onto the cup 450, which remains stationary on the cup support 422. However, unlike in the system 200, the first controller 432 can control the liquid pump 430 (e.g., a gear pump) to directly pump or transfer the ingredients 412 from the ingredient container 410 into and through the nozzle 440 (without pooling the ingredients 412 inside the housing 426). In some embodiments, the liquid pump 430 comprises a stable or constant pressure pump. Depending on factors such as the viscosity of the ingredients 412, the shape of the nozzle 440, and the pressure applied by the liquid pump 430, the ingredients 412 can be driven through an outlet of the nozzle 440 in a spray pattern, in a stream or jet, in an oozing manner, etc. Thus, by controlling the liquid pump 430, the actuator 436, and/or the motor 438, the system 400 can apply a desired cup decoration pattern onto the inner surface of the cup 450.

In some embodiments, the system 400 further includes a pressure regulator or balancer (not shown) to maintain the dispense pressure while dispensing the ingredients 412 through the nozzle 440 to control the dispense quality of the ingredients 412, thereby ensuring proper decoration of the cup 450. In some embodiments, the ingredient container 410 is positioned above or on top of the cup decoration device 420 such that the pump 430 (e.g., a gear pump) can prime the ingredients 412 (e.g., in liquid form) statically without a pressure regulator.

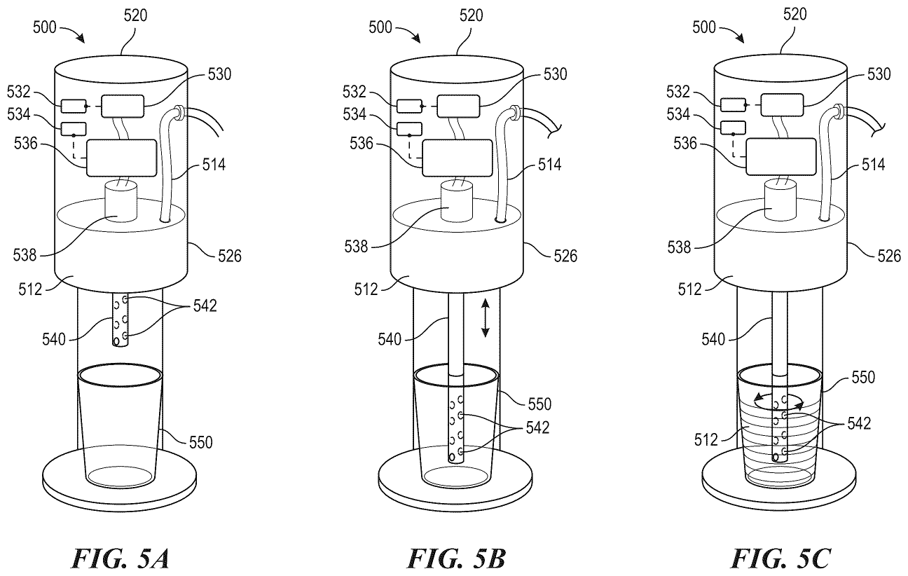

FIGS. 5A-5C illustrate a series of operation steps of another cup decoration system 500 (“the system 500”) configured in accordance with embodiments of the present technology. Like the system 200, the system 500 can include an ingredient container (not shown) and a cup decoration device 520 coupled to the ingredient container via a tube 514. The cup decoration device 520 can include a housing 526 in which ingredients 512 can be pooled, a pump 530, a first controller 532, a second controller 534, an actuator 536, a motor 538, and a nozzle 540. Unlike the nozzle 240 illustrated in FIGS. 2-3D, the nozzle 540 comprises an elongate, straight, cylindrical shaft with a plurality of holes or apertures 542 along a sidewall of the nozzle 540. The apertures 542 can be distributed on the sidewall of the nozzle 540 along the length and circumference of the nozzle 540. The bottom of the nozzle 540 can be sealed or at least partially open.

In operation of the system 500, the actuator 536 can move the nozzle 540 between a retracted state (FIG. 5A) in which the nozzle 540 is positioned above the cup 550 and an extended state (FIG. 5B) in which the nozzle 540 is positioned at least partially inside the cup 550. Also, as shown in FIG. 5B, the apertures 542 can be included on a lower portion of the nozzle 540 that is positioned inside the cup 550 when the nozzle 540 is in the extended state, but not on an upper portion of the nozzle 540 that remains above and outside of the cup 550 when the nozzle 540 is in the extended state. Moreover, as shown in FIG. 5C, as the pump 530 drives (e.g., by applying a static air pressure, by directly pumping) the ingredients 512 through the nozzle 540, the motor 538 can rotate the nozzle 540 about a longitudinal axis of the nozzle 540. Because the apertures 542 are distributed along the length of the nozzle 540, the ingredients 512 can be applied to various heights of the inner surface of the cup 550 simultaneously without moving the nozzle 540 vertically via the actuator 536. In some embodiments, however, the actuator 536 can move the nozzle 540 vertically while the nozzle 540 dispenses the ingredients 512. Moreover, because the apertures 542 are only included on the lower portion of the nozzle 540, the ingredients 512 are not applied beyond the cup 550 (e.g., at heights between the housing 526 and the cup 550). The operation of the pump 530, the actuator 536, and the motor 538, and/or the pattern of the apertures 542 on the nozzle 540 can be based on, for example, the viscosity of the ingredients 512 and the desired cup decoration pattern.

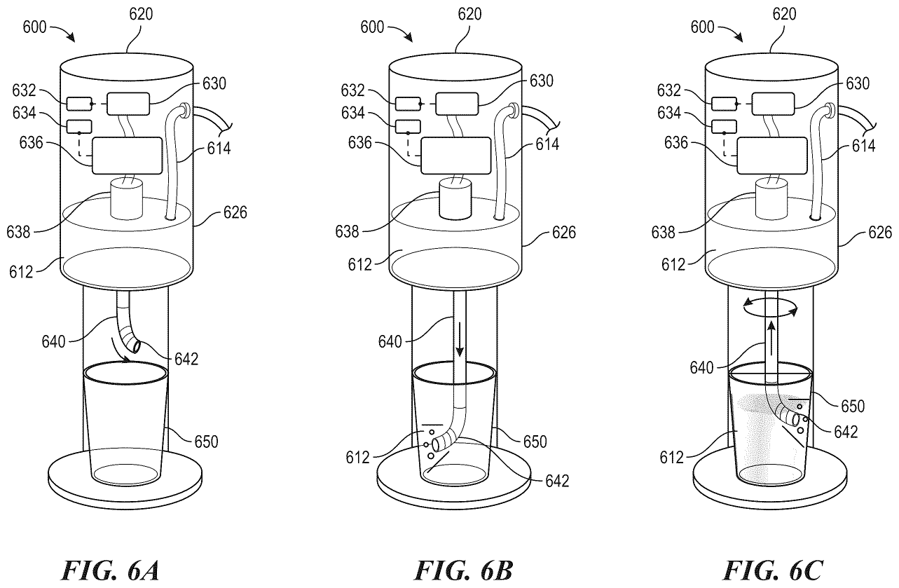

FIGS. 6A-6C illustrate a series of operation steps of another cup decoration system 600 (“the system 600”) configured in accordance with embodiments of the present technology. Like the system 200, the system 600 can include an ingredient container (not shown) and a cup decoration device 620 coupled to the ingredient container via a tube 614. The cup decoration device 620 can include a housing 626 in which ingredients 612 can be pooled, a pump 630, a first controller 632, a second controller 634, an actuator 636, a motor 638, and a nozzle 640. Unlike the nozzle 240 illustrated in FIGS. 2-3D, the nozzle 640 comprises an elongate, cylindrical shaft with a curved distal end portion 642 defining an outlet. In some embodiments, the distal end portion 642 is rigid with a fixed curvature. In some embodiments, the distal end portion is a deformable distal end portion configured to retain a shape imparted thereon (e.g., manually by a user, by the actuator 636).

In operation of the system 600, the actuator 636 can move the nozzle 640 between a retracted state (FIG. 6A) in which the nozzle 640 is positioned above the cup 650 and an extended state (FIG. 6B) in which the nozzle 640 is positioned at least partially inside the cup 650. As shown in FIG. 6B, the pump 630 can drive the ingredients 612 out through the outlet of the nozzle 640 while the distal end portion 642 is curved, allowing the ingredients 612 to be applied to the inner sidewall of the cup 650. As shown in FIG. 6C, the actuator 636 can move the nozzle 640 towards the retracted state to move the distal end portion 642 upward, and the motor 638 can rotate the nozzle 640 about a longitudinal axis of the nozzle 640. The operation of the pump 630, the actuator 636, and the motor 638, and/or the curvature of the distal end portion 642 of the nozzle 640 can be based on, for example, the viscosity of the ingredients 612 and the desired cup decoration pattern.

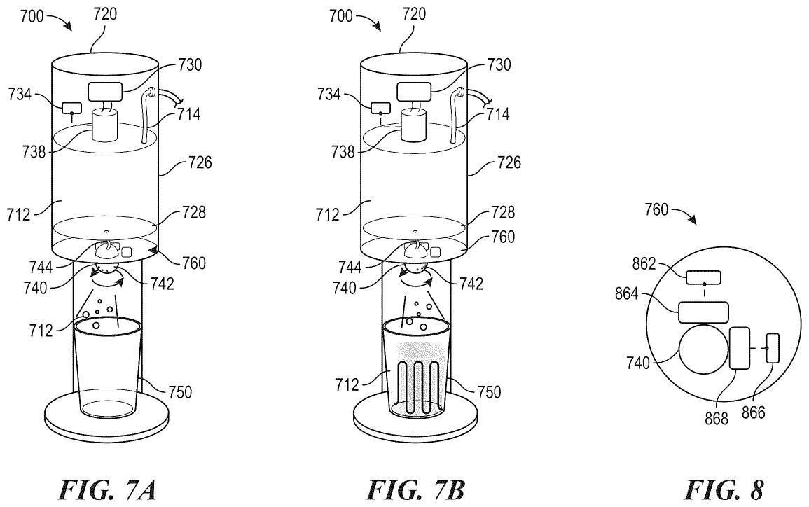

FIGS. 7A and 7B illustrate a series of operation steps of another cup decoration system 700 (“the system 700”) configured in accordance with embodiments of the present technology. Like the system 200, the system 700 can include an ingredient container (not shown) and a cup decoration device 720 coupled to the ingredient container via a tube 714. The cup decoration device 720 can include a housing 726 in which ingredients 712 can be pooled, a pump 730, a first controller 734, a first motor 738, and a nozzle 740. The system 700 can further include a partition 728 positioned inside the housing 726. The partition 728 can divide the interior of the housing 726 into an upper or first compartment in which the ingredients 712 can be pooled (e.g., the partition 728 can serve as a floor for supporting the ingredients 712), and a lower or second compartment in which an electronics bay 760 can be stored. The electronics bay 760 is illustrated in and discussed in further detail below with reference to FIG. 8.

Unlike the nozzle 240 illustrated in FIGS. 2-3D, the nozzle 740 comprises a spherical or ellipsoid structure with one or more apertures 742 and a tube 744 coupled to the first compartment of the housing 726. In the illustrated embodiment, the nozzle 740 is positioned partially inside the second compartment of the housing 726 and partially outside the housing 726. The apertures 742 can be positioned on the portion of the nozzle 740 outside the housing 726 and facing generally downward. In particular, the apertures 742 can be arranged off-center and towards a side of the nozzle 740 (e.g., not facing directly downward) such that when the nozzle 740 is centered with the cup 750, as shown, the ingredients 712 can be sprayed or otherwise dispensed onto the sidewall of the cup 750. The tube 744 can fluidly couple the nozzle 740 to the first compartment of the housing 726 through an aperture of the partition 728 such that the nozzle 740 can receive the ingredients 712 pooled therein.

FIG. 8 is a partially schematic illustration of the electronics bay 760. As shown, the electronics bay 760 can include a second controller 862, a second motor 864 operably coupled to the second controller 862, a third controller 866, and a third motor 868 operably coupled to the third controller 866. Each of the first motor 738, the second motor 864, and the third motor 868 can be coupled to rotate the nozzle 740 about one or more rotational axes. As aforementioned, these components can be housed in the second compartment of the housing 726, which is fluidly isolated from the pooled ingredients 712 in the first compartment of the housing 726.

Referring to FIGS. 7A-8 together, in operation of the system 700, the pump 730 can drive the ingredients 712 from the first compartment, through the tube 744, and out through the apertures 742 of the nozzle 740. The first motor 738, the second motor 864, and the third motor 868 can be operated (e.g., via their respective controllers 734, 862, 866) to rotate the nozzle 740 about one or more rotational axes. Because the apertures 742 are generally arranged on one portion or side of the nozzle 740, the nozzle 740 can be rotated to apply the ingredients 712 onto different portions of the inner surface of the cup 750 and thus create a desired cup decoration pattern. The operation of the pump 730, the first motor 738, the second motor 864, and the third motor 868, and/or the number and arrangement of the apertures 742 on the nozzle 740 can be based on, for example, the viscosity of the ingredients 712 and the desired cup decoration pattern.

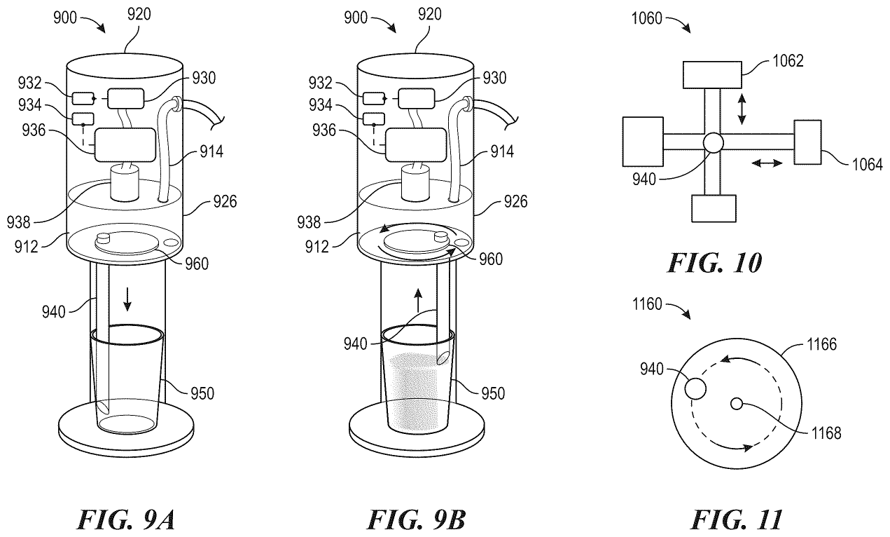

FIGS. 9A and 9B illustrate a series of operation steps of another cup decoration system 900 (“the system 900”) configured in accordance with embodiments of the present technology. Like the system 200, the system 900 can include an ingredient container (not shown) and a cup decoration device 920 coupled to the ingredient container via a tube 914. The cup decoration device 920 can include a housing 926 in which ingredients 912 can be pooled, a pump 930, a first controller 932, a second controller 934, an actuator 936, a motor 938, and a nozzle 940. The system 900 can further include a nozzle moving assembly 960 at the bottom of the housing 926 and coupled to the nozzle 940. Examples of the nozzle moving assembly 960 are illustrated in and discussed in further detail below with reference to FIGS. 10 and 11. Like the nozzle 240 illustrated in FIGS. 2-3D, the nozzle 940 comprises an elongate, cylindrical shaft. In the illustrated embodiment, the nozzle 940 extends along a portion of the inner surface of the cup 950 and includes a slanted opening that faces the portion of the inner surface of the cup 950 such that the ingredients 912 can be dispensed thereto.

FIG. 10 is a partially schematic illustration of a nozzle moving assembly 1060 configured in accordance with embodiments of the present technology. The nozzle moving assembly 1060 can be an example of the nozzle moving assembly 960 illustrated in and described above with reference to FIGS. 9A and 9B. The nozzle moving assembly 1060 can include a first actuator 1062 (e.g., a first linear actuator) and a second actuator 1064 (e.g., a second linear actuator), each coupled to move the nozzle 940. As shown, the first and second actuators 1062, 1064 can move the nozzle 940 along first and second axes, respectively (e.g., along rails). In some embodiments, the two axes are oriented perpendicular or normal to the length of the nozzle 940 and to one another such that the nozzle moving assembly 1060 can move the nozzle 940 along, for example, an x-axis and a y-axis.

FIG. 11 is a partially schematic illustration of another nozzle moving assembly 1160 configured in accordance with embodiments of the present technology. The nozzle moving assembly 1160 can be an example of the nozzle moving assembly 960 illustrated in and described above with reference to FIGS. 9A and 9B. The nozzle moving assembly 1160 can include a circular platform or disc 1166 and a motor 1168 coupled to rotate the disc 1166. The nozzle 940 can be coupled to the disc 1166 off-center such that rotation of the disc 1166 by the motor 1168 rotates the nozzle 940 about a rotational axis offset from a longitudinal axis of the nozzle 940. Moreover, as seen in FIGS. 9A and 9B, rotation of the nozzle 940 via rotation of the disc 1166 can keep the slanted opening of the nozzle 940 facing radially outward and towards an adjacent portion of the inner surface of the cup 950.

In some embodiments, aspects of the nozzle moving assembly 1060 are combined with aspects of the nozzle moving assembly 1160. For example, instead of moving the nozzle 940, the nozzle moving assembly 1060 can be coupled to move the disc 1166 along x- and y-axes. Therefore, in operation, a combined nozzle moving assembly can move the nozzle 940 along x- and y-axes, as described above with reference to FIG. 10, and rotate the nozzle 940 about an offset rotational axis, as described above with reference to FIG. 11, allowing a greater degree of freedom.

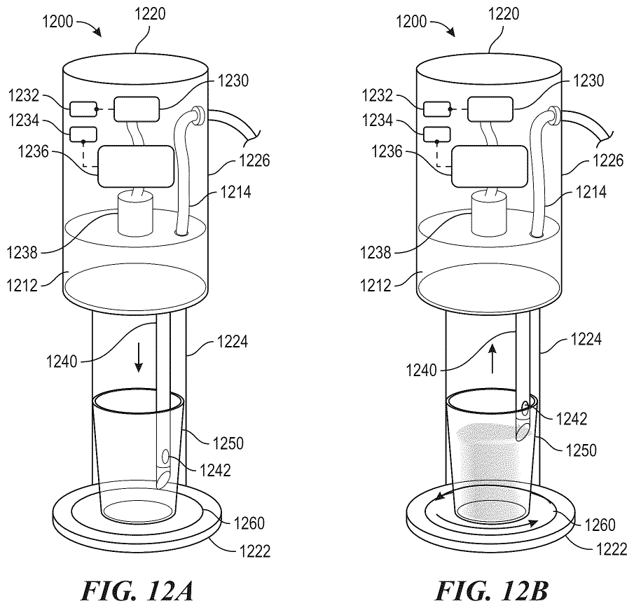

FIGS. 12A and 12B illustrate a series of operation steps of another cup decoration system 1200 (“the system 1200”) configured in accordance with embodiments of the present technology. Like the system 200, the system 1200 can include an ingredient container (not shown) and a cup decoration device 1220 coupled to the ingredient container via a tube 1214. The cup decoration device 1220 can include a cup support 1222, a housing 1226, and a stem 1224 extending therebetween. In the illustrated embodiment, the cup support 1222 comprises a circular base or platform on which a cup 1250 can be placed. The stem 1224 extends upward from a perimeter of the cup support 1222 to support the housing 1226 above the cup 1250.

The cup decoration device 1220 can further include a pump 1230, a first controller 1232, a second controller 1234, an actuator 1236, a motor 1238, a nozzle 1240, and one or more sensors 1242. The nozzle 1240 comprises an elongate, cylindrical shaft that can receive the ingredients 1212 pooled inside the housing 1226, and can extend downward from the housing 1226 towards the cup 1250, as shown. Also, the nozzle 1240 includes a distal end portion with a slanted tip defining an outlet of the nozzle 1240. The sensors 1242 can be coupled to the distal end portion of the nozzle 1240 generally facing the same direction as the outlet of the nozzle 1240 (e.g., facing the closest portion of the inner sidewall of the cup 1250). In some embodiments, the sensors 1242 are distance sensors, and can effectively measure the distance between the outlet of the nozzle 1240 and the adjacent portion of the inner sidewall of the cup 1250. The cup support 1222 can include a rotatable platform 1260 on which the cup 1250 can be supported, and the motor 1238 can rotate the cup 1250 as discussed in further detail below.

In operation of the system 1200, like in operation of the system 200 as discussed above with reference to FIGS. 3A-3D, the nozzle 1240 can dispense or otherwise apply the ingredients 1212 from the ingredient container onto the inner surface of the cup 1250. The actuator 1236 can move the nozzle 1240 between an extended state (FIG. 12A) and a retracted state (FIG. 12B) by lowering or raising the nozzle 1240. The nozzle 1240 can be otherwise fixed relative to the housing 1226 and positioned such that when the cup 1250 is centered on the cup support 1222, the nozzle 1240 is adjacent (e.g., may contact or not contact) the inner sidewall of the cup 1250. The motor 1238 can rotate the rotatable platform 1260 about a central axis of the circular rotatable platform 1260. Because the nozzle 1240 extends a longitudinal axis offset from the central axis of the rotatable platform 1260, and the nozzle 1240 remains stationary except for vertical movement by the actuator 1236, rotation of the cup 1250 by the motor 1238 can allow the nozzle 1240 to dispense the ingredients 1212 onto any and all portions of the inner sidewall of the cup 1250. Furthermore, distance measurements from the sensors 1242 can be used to more precisely control operation of the pump 1230, the actuator 1236, and/or the motor 1238 to create a desired cup decoration pattern.

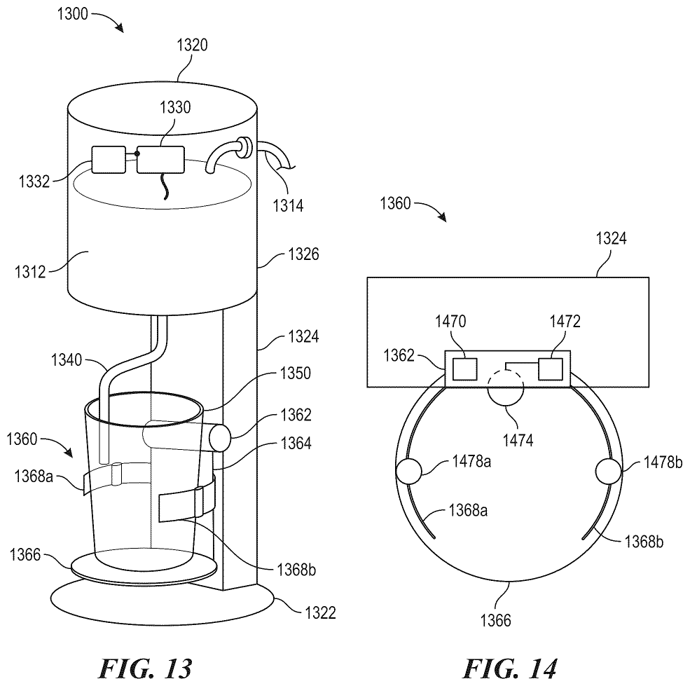

FIG. 13 is a partially schematic illustration of another cup decoration system 1300 (“the system 1300”) configured in accordance with embodiments of the present technology. The system 1300 can include an ingredient container (not shown) and a cup decoration device 1320 coupled to receive ingredients 1312 from the ingredient container. The cup decoration device 1320 can include a base 1322, a housing 1326, a stem 1324 extending therebetween, a controller 1332, and a pump 1330. The cup decoration device 1320 can further include a nozzle 1340 coupled to and extending from the housing 1326 and a cup support 1360 coupled to the stem 1324. In the illustrated embodiment, the cup support 1360 supports a cup 1350, and the nozzle 1340 extends from a central portion of the cylindrical housing 1326 and bends to reach down along an inner sidewall of the cup 1350.

The cup support 1360 can include a platform 1366 on which the cup 1350 can sit, a latch 1362 coupled to the stem 1324, a lever arm 1364 extending therebetween, and first and second arms 1368a, 1368b extending from either side of the lever arm 1364. As shown, the first and second arms 1368a, 1368b can have curvatures to generally extend around the sidewall of (or circumferentially wrap around) the cup 1350, preventing the cup 1350 from falling out during operation of the system 1300. In some embodiments, the first and second arms 1368a, 1368b are elastic and/or coupled to biasing members (e.g., springs) such that the cup 1350 can be pushed sideways between the first and second arms 1368a, 1368b and onto the platform 1366. As discussed in further detail herein, the platform 1366 can rotate (e.g., tilt) about the latch 1362 to rotate the cup 1350 relative to the nozzle 1340.

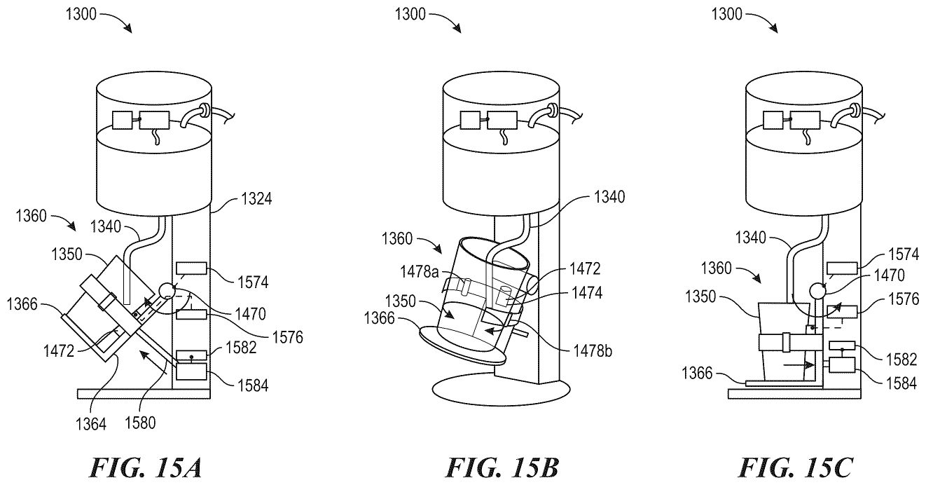

FIG. 14 is a top, cutaway view of the system 1300, particularly illustrating select components of the cup support 1360. As shown, the cup support 1360 can further include a first motor 1470 operably coupled to the latch 1362, a first roller 1474, a second motor 1472 operably coupled to the first roller 1474, and second and third rollers 1478a, 1478b. The first roller 1474 can be coupled to the lever arm 1364 (FIG. 13) and exposed such as to contact the cup 1350. The second and third rollers 1478a, 1478b can be coupled to the first and second arms 1368a, 1368b, respectively, and also exposed such as to contact the cup 1350. As discussed further below with reference to FIGS. 15A-15C, the first motor 1470 can rotate the latch 1362 (and thus the rest of the cup support 1360) relative to the stem 1324, and the second motor 1472 can rotate the first roller 1474, thereby rotating the cup 1350 on the second and third rollers 1478a, 1478b. In some embodiments, the cup support 1360 omits the first motor 1470 and the latch 1362 is freely (e.g., manually) rotatable.

FIGS. 15A-15C illustrate a series of operation steps of the system 1300.

Referring first to FIG. 15A, the cup support 1360 can further include a first controller 1574 operably coupled to the first motor 1470, a second controller 1576 operably coupled to the second motor 1472, an actuator 1584, and a third controller 1582 operably coupled to the actuator 1584. Each of the aforementioned components can be housed within the stem 1324 (as schematically shown) or elsewhere in the system 1300). In operation, as shown, the first controller 1574 can control the first motor 1470 to rotate the platform 1366 about the latch 1362 and away from the stem 1324. In some embodiments, the cup support 1360 omits the first controller 1574 and the first motor 1470, and the platform 1366 is freely rotatable about the latch 1362. The third controller 1582 can control the actuator 1584 to extend a strut 1580 that extends between the stem 1324 and the lever arm 1364. The actuator 1584 and the strut 1580 can facilitate rotation of the platform 1366, and thus the cup 1350, by reducing the mechanical load on the first motor 1470. In some embodiments, only the actuator 1584 and the strut 1580, and not the first motor 1470, are operated to rotate the platform 1366 about the latch 1362. As the platform 1366 rotates about the latch 1362, the cup 1350 is repositioned and reoriented relative to the nozzle 1340 such that the outlet of the nozzle 1340 is adjacent to a different portion of the inner surface of the cup 1350.

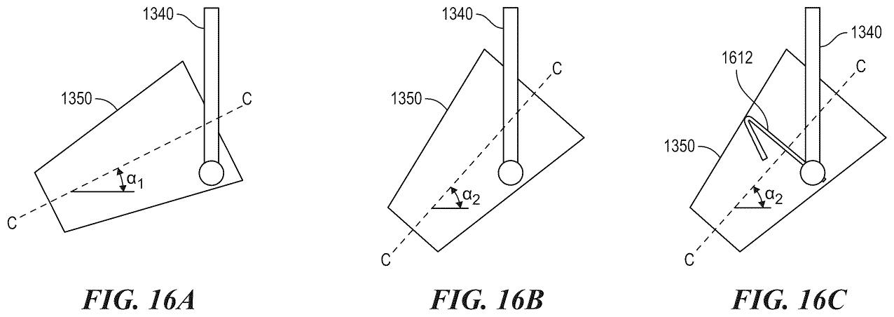

Referring next to FIG. 15B, the second controller 1576 can control the second motor 1472 to rotate the first roller 1474, which contacts the cup 1350. The first roller 1474 can comprise a relatively high-friction material (e.g., rubber) such that rotation of the first roller 1474 in turn rotates the cup 1350 about its central axis. As aforementioned, the second and third rollers 1478a, 1478b can freely rotate such that only the first roller 1474 drives rotation of the cup 1350. The second and third rollers 1478a, 1478b can contact the cup 1350 to secure the cup 1350 within the first and second arms 1368a, 1368b. As the cup 1350 rotates along the first, second, and third rollers 1474, 1478a, 1478b, the cup 1350 is reoriented relative to the nozzle 1340 such that the outlet of the nozzle 1340 is adjacent to a different portion of the inner surface of the cup 1350. As described in further detail below with reference to FIGS. 16A-16C, the motions described with reference to FIGS. 15A and 15B can be combined to create a desired cup decoration pattern on the inner surface of the cup 1350.

Referring next to FIG. 15C, once the cup 1350 is decorated, the first controller 1574 can control the first motor 1470 to rotate the platform 1366 about the latch 1362 and back towards from the stem 1324. The third controller 1582 can control the actuator 1584 to retract the strut 1580. As aforementioned, the actuator 1584 and the strut 1580 can facilitate rotation of the platform 1366, and thus the cup 1350, by reducing the mechanical load on the first motor 1470. In some embodiments, the first motor 1470 is omitted and the actuator 1584 is used to rotate the cup support 1360 about the latch 1362. Once the cup support 1360 returns to its original position, the decorated cup 1350 can subsequently be retrieved from the cup support 1360.

FIGS. 16A-16C schematically illustrate a series of operation steps in accordance with embodiments of the present technology. Referring first to FIG. 16A, the cup 1350 can be positioned and oriented (e.g., on the cup support 1360) such that a central axis C-C of the cup 1350 is at a first angle α₁ from the horizontal. The outlet of the nozzle 1340 is positioned adjacent to an inner surface of the cup 1350, and more specifically adjacent to the opening of the cup 1350. Referring next to FIG. 16B, the cup 1350 can be repositioned and reoriented (e.g., on the cup support 1360) such that the central axis C-C of the cup 1350 is at a second angle α₂ from the horizontal. The second angle α₂ can be greater than the first angle α₁ such that the outlet of the nozzle 1340 is positioned farther from the opening of the cup 1350. Referring next to FIG. 16C, the cup 1350 can be reoriented (e.g., on the cup support 1360) such that the cup 1350 rotates about the central axis C-C. In some embodiments, the change in the angle α can be combined with the rotation about the central axis C-C to create a spiral cup decoration pattern (e.g., as partially illustrated in FIG. 16C) or other desired cup decoration pattern on the inner surface of the cup 1350.

One of ordinary skill in the art will appreciate that different features included in the different embodiments of the cup decoration systems described above and illustrated in FIGS. 2-15C can be combined in various ways. For example, while the systems illustrated in FIGS. 5A-15C are illustrated with ingredients pooled inside the container and driven through the nozzle via an air pump, as described above with reference to FIGS. 2-3D, in other embodiments, each of those systems can drive the ingredients directly from the ingredient container through the nozzle, as described above with reference to FIG. 4. As another example, any of the various nozzle configurations, such as the deformable nozzle 640 (FIGS. 6A-6C) or the ellipsoidal nozzle 740 (FIGS. 7A and 7B), can be combined with any of the motorized cup supports, such as the cup support 1222 with the rotatable platform 1260 (FIGS. 12A and 12B) or the cup support 1360 (FIGS. 13-15C). As yet another example, any of the various nozzle moving mechanisms, such as the nozzle moving assembly 960 and variants thereof (FIGS. 9A-11), can be combined with any of the motorized cup supports.

### C. Example Cup Decoration Patterns

FIGS. 17-22 illustrate various cup decoration patterns that can be produced by systems configured in accordance with embodiments of the present technology. It will be appreciated that the illustrated patterns are merely examples, and that other patterns can be formed using systems described herein. Also, it will be appreciated that the cup decoration patterns can be positive (e.g., the ingredients make up the lines, rings, raindrops, etc.) or negative (e.g., the lack of ingredients make up the lines, rings, raindrops, etc.). Furthermore, the patterns can be formed by applying multiple different ingredients (e.g., having different colors for visual contrast). In some embodiments, the layer of ingredients is dispensed onto the inner surface of the cup to provide a matte texture.

FIG. 17 illustrates a cup decoration pattern including a plurality of concentric rings arranged along a height of a cup 1750. The illustrated cup decoration pattern can be formed by, for example, rotating the nozzle fully around at a constant height, moving the nozzle up or down to a different height, and repeating.

FIG. 18 illustrates a cup decoration pattern including a serpentine line repeatedly extending between upper and lower portions of and along the circumference of a cup 1850. The illustrated cup decoration pattern can be formed by, for example, moving the nozzle upward, rotating the nozzle and/or the cup (e.g., by about 3-5% of a full rotation), moving the nozzle downward, rotating the nozzle and/or the cup (e.g., again, by about 3-5% of a full rotation), and repeating.

FIG. 19 illustrates a cup decoration pattern including a plurality of raindrops on the inner surface of a cup 1950. The illustrated cup decoration pattern can be formed by, for example, spraying the ingredients onto a spot on the inner surface of the cup 1950 for a short period of time to form a raindrop shape, moving the nozzle and/or the cup to a new spot on the inner surface of the cup 1950, and repeating.

FIG. 20 illustrates a cup decoration pattern including a solid layer on the inner surface of a cup 2050. The illustrated cup decoration pattern can be formed by, for example, translating and/or rotating the nozzle and/or the cup to apply the ingredients onto the entirety of the inner surface of the cup 2050 (or until a specified height thereof).

FIG. 21 illustrates a cup decoration pattern including a solid layer on the inner surface of a cup 2150 and a cover pattern over the top of the cup 2150. The cover pattern over the top of the cup 2150 can be formed by, for example, positioned the nozzle at the top of the cup 2150 and moving and/or rotating the nozzle or the cup to form the pattern (e.g., onto the top surface of a drink).

FIG. 22 illustrates a cup decoration pattern including a gradient and/or matte layer on the inner surface of a cup 2250. The gradient layer can be formed by, for example, using a nozzle with multiple small holes to produce a high pressure spray. The nozzle can be controlled to apply multiple layers at the very bottom of the inner surface of the cup 2250, and apply fewer and fewer layers as the nozzle moves up to create a gradient with darker colors at the bottom. Alternatively or additionally, the nozzle and/or the spray can be adjusted during operation such that a less concentrated spray is applied as the nozzle moves up. It is appreciated that the gradient pattern can be applied in other directions (e.g., darker colors at the top, the gradient extending circumferentially around the cup 2250, etc.).

In some embodiments, the predetermined pattern comprises an image pattern to be interpreted by one or more graphics engines (e.g., included in the cup decoration system). In some embodiments, the predetermined pattern comprises data that algorithmically represents the pattern. The data can be processed by a controller (e.g., the controllers 232, 234, 432, 434) or processor in order to render the predetermined pattern onto the inner surface (or elsewhere) of the cup to be decorated. For example, the graphics engine, controller, and/or processor can process the image and/or data to determine what ingredients to use, where and where not to apply the ingredients, how to move the nozzle and/or the cup, etc. to render the predetermined pattern onto the cup.

### D. Additional Embodiments of Cup Decoration Systems

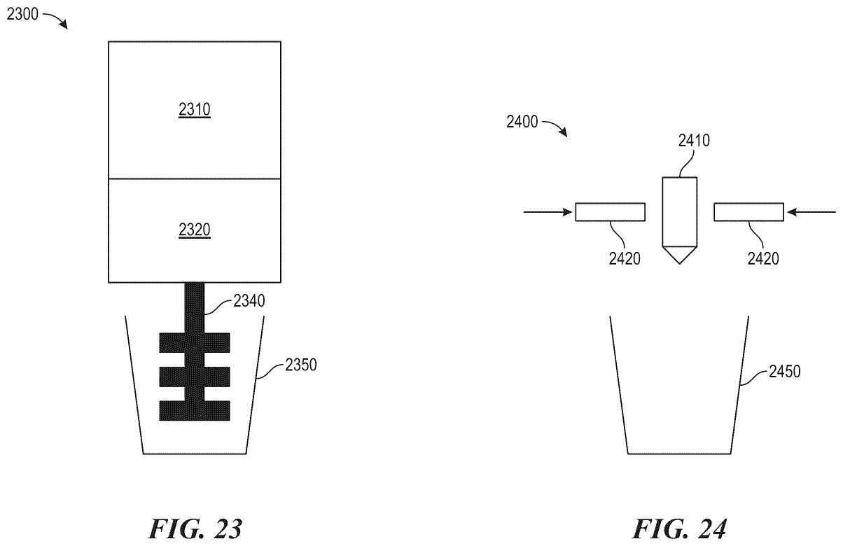

FIG. 23 schematically illustrates a cup decoration system 2300 configured in accordance with embodiments of the present technology. The cup decoration system 2300 includes an ingredient container 2310, a cup decoration device 2320, and a pattern creator 2340. The cup decoration device 2320 can be an example of other cup decoration devices illustrated and described herein (e.g., the cup decoration device 220, the cup decoration device 420), and can include a mechanism for dispensing ingredients (e.g., a pump, a nozzle) and a motor for actuating the pattern creator 2340. Notably, the ingredient container 2310 is positioned above (e.g., on top of) the cup decoration device 2320. This can enable the pump of the cup decoration device 2320 to prime the ingredients statically without, e.g., a pressure regulator.

In the illustrated embodiment, the pattern creator 2340 comprises an elongate member that can extend into a cup 2350, and one or more flanges at various heights along the elongate member. In operation, the dispensing mechanism of the cup decoration device 2320 can dispense the ingredients onto the pattern creator 2340, and the motor of the cup decoration device 2320 can rotate the pattern creator 2340 about its longitudinal axis to spin. Spinning the pattern creator 2340 can cause the ingredients on the pattern creator 2340 to be splattered, drizzled, or otherwise applied onto the inner surface of the cup 2350. The various flanges of the pattern creator 2340 can correspond to various heights at which the ingredients can be applied onto the inner surface of the cup 2350.

FIG. 24 schematically illustrates a cup decoration system 2400 configured in accordance with embodiments of the present technology. The cup decoration system 2400 can include one or more squeezing mechanisms, such as grippers 2420 that can, in operation, hold and squeeze an ingredient container 2410 (e.g., a silicone or plastic bottle amenable to squeezing) to dispense the ingredients stored therein onto the cup 2450. The grippers 2420 can be moved to various positions relative to the cup 2450 (e.g., above the cup 2450 as shown, adjacent to the cup 2450 such that the ingredient container 2410 extends into the cup 2450, around the sides of the cup 2450), and the degree of squeezing can be controlled based on the viscosity of the ingredient, the position of the ingredient container 2410 relative to the cup 2450, the desired cup decoration pattern, etc. It is appreciated that the cup decoration system 2400 can apply patterns on the inner surface and/or the outer surface of the cup 2450. Also, the ingredient container 2410 can be part of the cup decoration system 2400 or comprise an ingredient bottle that a user can manually swap out as needed.

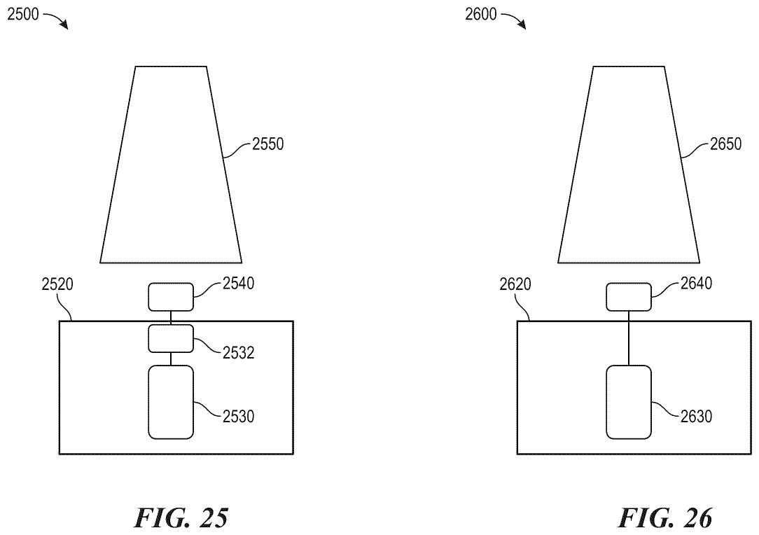

FIG. 25 schematically illustrates a cup decoration system 2500 configured in accordance with embodiments of the present technology. The cup decoration system 2500 can include a cup decoration device 2520 including an ingredient container 2530, a valve 2532 operably coupled to the ingredient container 2530, and a nozzle 2540. In some embodiments, the ingredient container 2530 is pressurized (e.g., at a pressure above atmospheric pressure) such that the valve 2532 can be controlled to selectively dispense ingredients onto the inner surface of a cup 2550 via the nozzle 2540. Notably, as illustrated, the cup 2550 is positioned above the cup decoration device 2520 and flipped upside down. The pressure in the ingredient container 2530 can be sufficient for the ingredients dispensed through the nozzle 2540 to reach various parts of the inner surface of the cup 2550. The nozzle 2540 can have various designs as illustrated and described above, and/or can be modular such that a user may swap out the nozzle 2540 for a differently designed nozzle. The valve 2532 can be passive or controllable. For example, in some embodiments, the valve 2532 can be configured to open when the cup 2550 is positioned near the nozzle 2540 (e.g., detected via sensors included in the cup decoration device 2520), when the cup 2550 is placed on the cup decoration device 2520 (e.g., thereby mechanically or electrically actuating the valve 2532), via a controller, etc.

FIG. 26 schematically illustrates a cup decoration system 2600 configured in accordance with embodiments of the present technology. The cup decoration system 2600 can include a cup decoration device 2620 including a pump 2630 and a nozzle 2540 operably coupled to the pump 2630. The pump 2630 can be operably coupled to an ingredient container (not shown in FIG. 26) as generally discussed above. In operation, the pump 2630 can be controlled to deliver the ingredients to the inner surface of a cup 2650 via the nozzle 2640. Notably, as illustrated, the cup 2650 is positioned above the cup decoration device 2620 and flipped upside down. The pressure provided by the pump 2630 can be sufficient for the ingredients dispensed through the nozzle 2640 to reach various parts of the inner surface of the cup 2650. The nozzle 2640 can have various designs as illustrated and described above, and/or can be modular such that a user may swap out the nozzle 2640 for a differently designed nozzle. In some embodiments, the pump 2630 can be configured to actuate automatically when the cup 2650 is positioned near the nozzle 2640 (e.g., detected via sensors included in the cup decoration device 2620), when the cup 2650 is placed on the cup decoration device 2620, via a controller, etc.

### E. Methods of Decorating a Cup

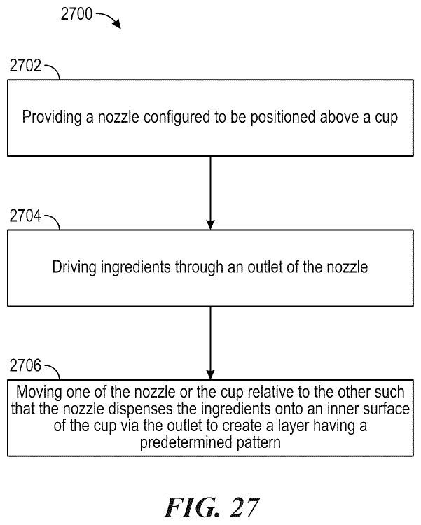

FIG. 27 is a flowchart illustrating a method 2700 for decorating a cup in accordance with embodiments of the present technology. While the steps of the method 2700 are described in a particular order herein, one or more of the steps can be performed in a different order or can be omitted, and the method 2700 can include additional steps.

The method 2700 can begin at block 2702 by providing a nozzle configured to be positioned above a cup. The cup can be supported on a stationary or motorized cup support. The nozzle can be movable (e.g., can be raised and lowered, can be translated along one or more axes, etc.) via one or more actuators, motors, etc.

At block 2704, the method 2700 continues by driving ingredients through an outlet of the nozzle. In some embodiments, the ingredients are pooled inside a housing and driven via an air pump. In some embodiments, the ingredients are directly pumped through the nozzle from a source. The nozzle can have various configurations, as described above. The outlet of the nozzle can include an opening at a distal end portion of the nozzle, a plurality of apertures along the sidewall of the nozzle, etc.

At block 2706, the method 2700 continues by moving one of the nozzle or the cup relative to the other such that the nozzle dispenses the ingredients onto an inner surface of the cup via the outlet to create a layer having a predetermined pattern. In some embodiments, the method 2700 can also include measuring a distance between the nozzle and the inner surface of the cup (e.g., using one or more sensors), and moving the nozzle can be based on the measured distance between the nozzle and the inner surface of the cup (e.g., forming a feedback system). In some embodiments, the method 2700 further includes moving the other of the nozzle or the cup to create the layer having the predetermined pattern.

### F. Computer Systems

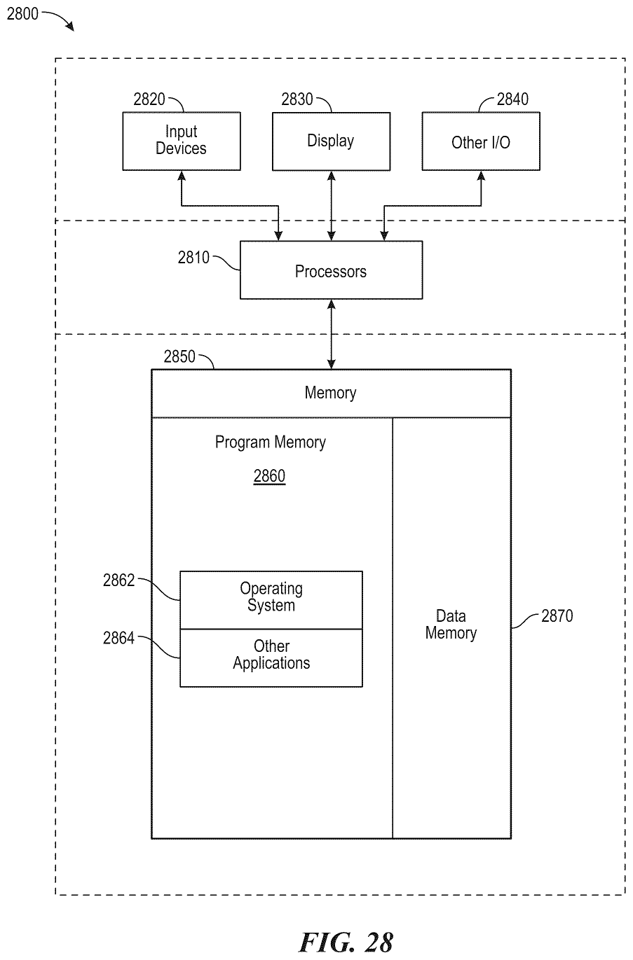

Several implementations are discussed below in more detail in reference to the figures. FIG. 28 is a block diagram illustrating an overview of devices on which some implementations of the disclosed technology can operate. The devices can comprise hardware components of a device 2800 that execute customized queries created from user selections, of query elements, that are based on meta-data from data set registrations. Device 2800 can include one or more input devices 2820 that provide input to the Processor(s) 2810 (e.g., CPU(s), GPU(s), HPU(s), etc.), notifying it of actions. The actions can be mediated by a hardware controller that interprets the signals received from the input device and communicates the information to the processors 2810 using a communication protocol. Input devices 2820 include, for example, a mouse, a keyboard, a touchscreen, an infrared sensor, a touchpad, a wearable input device, a camera- or image-based input device, a microphone, or other user input devices.

Processors 2810 can be a single processing unit or multiple processing units in a device or distributed across multiple devices. Processors 2810 can be coupled to other hardware devices, for example, with the use of a bus, such as a PCI bus or SCSI bus. The processors 2810 can communicate with a hardware controller for devices, such as for a display 2830. Display 2830 can be used to display text and graphics. In some implementations, display 2830 provides graphical and textual visual feedback to a user. In some implementations, display 2830 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2840 can also be coupled to the processor, such as a network card, video card, audio card, USB, firewire or other external device, camera, printer, speakers, CD-ROM drive, DVD drive, disk drive, or Blu-Ray device.

In some implementations, the device 2800 also includes a communication device capable of communicating wirelessly or wire-based with a network node. The communication device can communicate with another device or a server through a network using, for example, TCP/IP protocols. Device 2800 can utilize the communication device to distribute operations across multiple network devices.

The processors 2810 can have access to a memory 2850 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2850 can include program memory 2860 that stores programs and software, such as an operating system 2862 and other application programs 2864. Memory 2850 can also include data memory 2870, e.g., predetermined decoration patterns (e.g., graphics, images), ingredient selections and motor and/or pump controls corresponding to the predetermined decoration patterns, table data, column data, value filter data, user interface data, database element data, selection data, root table data, code snippet data, join query data, query template data, connection data, configuration data, settings, user options or preferences, etc., which can be provided to the program memory 2860 or any element of the device 2800.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

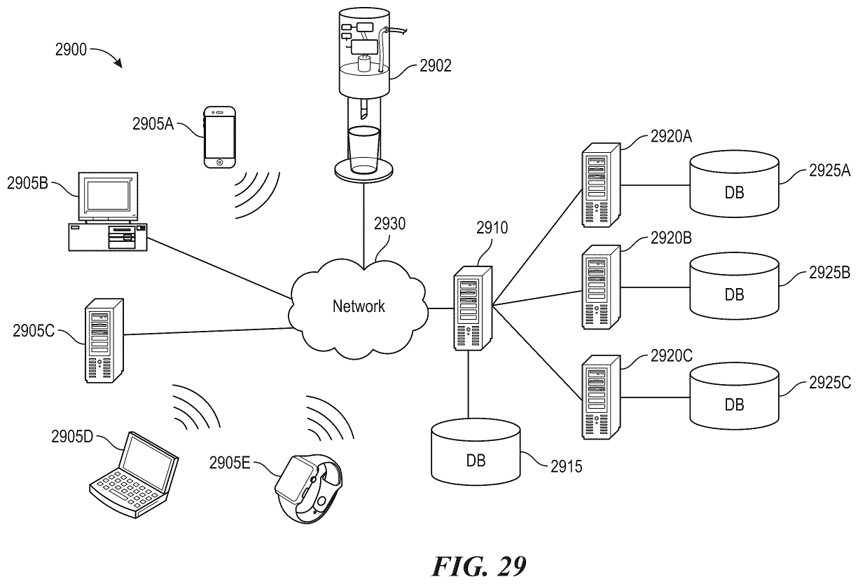

FIG. 29 is a block diagram illustrating an overview of an environment 2900 in which some implementations of the disclosed technology can operate. Environment 2900 can include one or more client computing devices 2905A-E (collectively referred to as “client computing devices 2905”) and a cup decoration system 2902. Client computing devices 2905 and the cup decoration system 2902 can operate in a networked environment using logical connections through network 2930 to one or more remote computers, such as a server computing device.

In some implementations, server 2910 can be an edge server which receives client requests and coordinates fulfillment of those requests through other servers, such as servers 2920A-C. Server computing devices 2910 and 2920 can comprise computing systems, such as device 2800. Though each server computing device 2910 and 2920 is displayed logically as a single server, server computing devices can each be a distributed computing environment encompassing multiple computing devices located at the same or at geographically disparate physical locations. In some implementations, each server 2920 corresponds to a group of servers.

Client computing devices 2905 and server computing devices 2910 and 2920 can each act as a server or client to other server/client devices. Server 2910 can connect to a database 2915. Servers 2920A-C can each connect to a corresponding database 2925A-C. As discussed above, each server 2920 can correspond to a group of servers, and each of these servers can share a database or can have their own database. Databases 2915 and 2925 can warehouse (e.g., store) information such as table data, column data, value filter data, user interface data, database element data, selection data, root table data, code snippet data, join query data, query template data, connection data. Though databases 2915 and 2925 are displayed logically as single units, databases 2915 and 2925 can each be a distributed computing environment encompassing multiple computing devices, can be located within their corresponding server, or can be located at the same or at geographically disparate physical locations.

Network 2930 can be a local area network (LAN) or a wide area network (WAN), but can also be other wired or wireless networks. Network 2930 may be the Internet, a mobile phone network, a mobile voice or data network (e.g., a 5G or Long Term Evolution (LTE) network), a cable network, a public switched telephone network, a short-range wireless communication network (e.g., Bluetooth or Near Field Communications (NFC)), or some other public or private network. Client computing devices 2905 can be connected to network 2930 through a wired or wireless network interface, such as a satellite path, a fiber-optic path, a cable path, a path that supports Internet communications (e.g., Internet Protocol television (IPTV)), free-space connections (e.g., for broadcast or other wireless signals), etc. While the connections between server 2910 and servers 2920 are shown as separate connections, these connections can be any kind of local, wide area, wired, or wireless network, including network 2930 or a separate public or private network. As described in further detail herein, the client computing devices 2905 and the cup decoration system 2902 can operate according to an edge computing protocol (e.g., an edge computing decryption protocol).

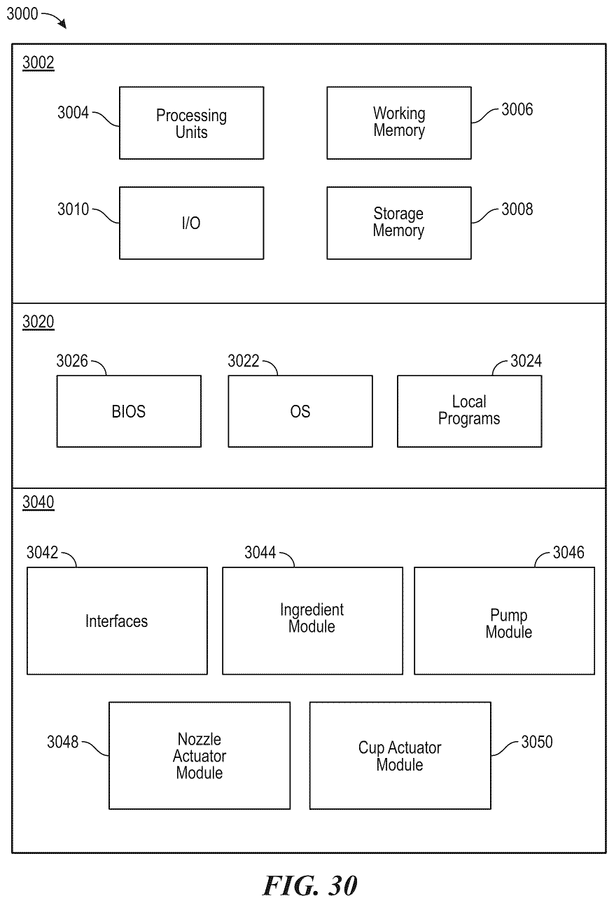

FIG. 30 is a block diagram illustrating components 3000 which, in some implementations, can be used in a system employing the disclosed technology. In some implementations, some or all of the components 3000 can be included in a cup decoration system. The components 3000 include hardware 3002, general software 3020, and specialized components 3040. As discussed above, a system implementing the disclosed technology can use various hardware including processing units 3004 (e.g., CPUs, GPUS, APUs, etc.), working memory 3006, storage memory 3008 (local storage or as an interface to remote storage, such as storage 2915 or 2925), and input and output devices 3010. In various implementations, storage memory 3008 can be one or more of: local devices, interfaces to remote storage devices, or combinations thereof. For example, storage memory 3008 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 2915 or storage provided through another server 2920). Components 3000 can include a machine-readable storage medium having machine executable instructions stored thereon. Components 3000 can be implemented in a client computing device such as client computing devices 2905, on the cup decoration system 2902, or on a server computing device, such as server computing device 2910 or 2920.

General software 3020 can include various applications including an operating system 3022, local programs 3024, and a basic input output system (BIOS) 3026. Specialized components 3040 can be subcomponents of a general software application 3020, such as local programs 3024. Specialized components 3040 can include ingredient module 3044, pump module 3046, nozzle actuator module 3048, and cup actuator module 3050, and components which can be used for providing user interfaces, transferring data, and controlling the specialized components, such as interfaces 3042. In some implementations, components 3000 can be in a computing system that is distributed across multiple computing devices or can be an interface to a server-based application executing one or more of specialized components 3040. Although depicted as separate components, specialized components 3040 may be logical or other nonphysical differentiations of functions and/or may be submodules or code-blocks of one or more applications.

In some implementations, the ingredient module 3044 is configured to manage inventory of one or more ingredients stored (e.g., in an ingredient container) and select which ingredients are to be delivered based on the desired cup decoration pattern. For example, an ingredient container can store 20 different ingredients, and upon receiving a signal or indication that a cup decoration pattern with mocha and caramel syrups is desired, the ingredient module 3044 can selectively provide those two ingredients.

In some implementations, the pump module 3046 is configured to manage the driving of the ingredients received from the ingredient container through and out of the nozzle. For example, the pump module 3046 can set the appropriate flow rate, dispensing quantity or volume, pressure, frequency, etc. depending on, for example, the desired cup decoration pattern and characteristics (e.g., viscosity) of the individual ingredients. In some embodiments, the pump module 3046 can communicate with other modules, such as the nozzle actuator module 3048 and the cup actuator module 3050, to coordinate dispensing of the ingredients with the movement of the nozzle relative to the cup.

In some implementations, the nozzle actuator module 3048 is configured to move a nozzle. For example, the nozzle actuator module 3048 can control an actuator to move the nozzle up and down along a longitudinal axis of the nozzle, and/or control one or more motors to rotate the nozzle (e.g., about the longitudinal axis of the nozzle, about a rotational axis offset from the longitudinal axis). In some embodiments, the nozzle actuator module 3048 can communicate with other modules, such as the pump module 3046 and the cup actuator module 3050, to coordinate dispensing of the ingredients with the movement of the nozzle relative to the cup.

In some implementations, the cup actuator module 3050 is configured to move a cup support. For example, the cup actuator module 3050 can control one or more motors and/or actuators to rotate and/or translate the cup support and the cup supported thereon. In some embodiments, the cup actuator module 3050 can communicate with other modules, such as the pump module 3046 and the nozzle actuator module 3048, to coordinate dispensing of the ingredients with the movement of the nozzle relative to the cup.

Those skilled in the art will appreciate that the components illustrated in FIGS. 28-30 described above may be altered in a variety of ways. For example, either of the nozzle actuator module 3048 or the cup actuator module 3050 may be omitted. In some implementations, one or more of the components described above can execute one or more of the processes described above.

### G. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.
1. A cup decoration device, comprising:
   a nozzle coupled to receive ingredients, wherein the nozzle includes an outlet, and wherein the nozzle is configured to be positioned adjacent to or partially inside a cup;
   a pump coupled to drive the ingredients through the outlet of the nozzle;
   a motor coupled to rotate the nozzle relative to the cup; and
   a controller operably coupled to the pump and the motor, wherein the controller is configured to operate the pump and the motor such that the nozzle dispenses the ingredients onto an inner surface of the cup via the outlet to create a layer having a predetermined pattern.
2. The cup decoration device of example 1, further comprising an actuator coupled to move the nozzle into and out of the cup.
3. The cup decoration device of example 1 or example 2, further comprising a housing coupled to the nozzle and configured to receive and store the ingredients, and wherein the pump comprises an air pump configured to apply an air pressure onto the ingredients to drive the ingredients through the outlet of the nozzle.
4. The cup decoration device of any of examples 1-3, wherein the pump is configured to directly pump the ingredients through the outlet of the nozzle.
5. The cup decoration device of any of examples 1-4, wherein the nozzle comprises an elongate, straight member having a slanted end defining the outlet, wherein the nozzle is configured to be positioned along a central axis of the cup.
6. The cup decoration device of any of examples 1-5, wherein the nozzle comprises an elongate, straight member, wherein the nozzle further includes a plurality of outlets including the outlet along a sidewall of the nozzle.
7. The cup decoration device of any of examples 1-6, wherein the nozzle comprises a deformable distal end portion defining the outlet, wherein the deformable distal end portion is configured to retain a shape imparted thereon.
8. The cup decoration device of any of examples 1-7, wherein the nozzle comprises an ellipsoid, and wherein the nozzle further includes a plurality of outlets including the outlet on the ellipsoid.
9. The cup decoration device of any of examples 1-8, wherein the motor is coupled to rotate the nozzle about a longitudinal axis of the nozzle.
10. The cup decoration device of any of examples 1-9, wherein the motor is coupled to rotate the nozzle about a rotation axis offset from a longitudinal axis of the nozzle.
11. The cup decoration device of any of examples 1-10, further comprising one or more actuators coupled to move the nozzle along one or more axes normal to a longitudinal axis of the nozzle.
12. The cup decoration device of any of examples 1-11, further comprising a sensor positioned on a distal end portion of the nozzle, wherein the sensor is configured to measure a distance between the nozzle and the inner surface of the cup.
13. A cup decoration device, comprising:
   a nozzle coupled to receive ingredients, wherein the nozzle includes an outlet, and wherein the nozzle is configured to be positioned adjacent to or partially inside the cup;
   a pump coupled to drive the ingredients through the outlet of the nozzle;
   a motor coupled to rotate the cup relative to the nozzle; and
   a controller operably coupled to the pump and the motor, wherein the controller is configured to operate the pump and the motor such that the nozzle dispenses the ingredients onto an inner surface of the cup via the outlet to create a layer having a predetermined pattern.
14. The cup decoration device of example 13, wherein the nozzle is positioned offset from a central axis of the cup and adjacent to the inner surface of the cup, and wherein the motor is coupled to rotate the cup about the central axis of the cup.
15. The cup decoration device of example 13 or example 14, further comprising:
   a housing coupled to the nozzle;
   a stem coupled to the housing; and
   a cup support coupled to the stem, the cup support comprising:
      a platform configured to support the cup; and
      a latch coupled between the stem and the platform, wherein the motor is coupled to rotate the platform about the latch.
16. The cup decoration device of any of examples 13-15, further comprising a linear actuator coupled to push on the cup support to rotate the platform about the latch.
17. The cup decoration device of any of examples 13-16, further comprising:
   a housing coupled to the nozzle;
   a stem coupled to the housing; and
   a cup support coupled to the stem, the cup support comprising:
      first and second arms positioned to circumferentially wrap around the cup; and
      first and second rollers coupled to the first and second arms, respectively, wherein the first and second rollers are configured to contact the cup; and
      a third roller positioned to contact the cup, wherein the motor is coupled to rotate the third roller to rotate the cup along the first and second rollers between the first and second arms.
18. A method for decorating a cup, comprising:
   providing a nozzle configured to be positioned adjacent to or partially inside a cup;
   driving ingredients through an outlet of the nozzle; and
   moving one of the nozzle or the cup relative to the other such that the nozzle dispenses the ingredients onto an inner surface of the cup via the outlet to create a layer having a predetermined pattern.
19. The method of example 18, further comprising measuring a distance between the nozzle and the inner surface of the cup, wherein moving the nozzle is based on the measured distance between the nozzle and the inner surface of the cup.
20. The method of example 18 or example 19, further comprising moving the other of the nozzle or the cup to create the layer having the predetermined pattern.
21. The method of any of examples 18-20, further comprising:
   moving one of the nozzle or the cup relative to the other such that the nozzle is positioned adjacent to or partially inside the cup; and
   driving the ingredients through the outlet such that the nozzle dispenses the ingredients onto a beverage prepared in the cup via the outlet.
22. A cup decoration device, comprising:
   an ingredient container storing ingredients, wherein the ingredient container is pressurized;
   a nozzle coupled to receive the ingredients from the ingredient container, wherein the nozzle includes one or more outlets;
   a valve operably coupled between the ingredient container and the nozzle; and
   a controller operably coupled to the nozzle, wherein the controller is configured to control the valve to control flow of the ingredients from the ingredient container to the nozzle such that the nozzle selectively dispenses the ingredients onto an inner surface of a cup positioned adjacent to the nozzle via the one or more outlets to create a layer of the ingredients thereon having a predetermined pattern.

### H. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations, shear strength, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

I/We claim:

1. A cup decoration device, comprising:
a nozzle coupled to receive ingredients, wherein the nozzle includes an outlet, and wherein the nozzle is configured to be positioned adjacent to or partially inside a cup;
a pump coupled to drive the ingredients through the outlet of the nozzle;
a motor coupled to rotate the nozzle relative to the cup; and
a controller operably coupled to the pump and the motor, wherein the controller is configured to operate the pump and the motor such that the nozzle dispenses the ingredients onto an inner surface of the cup via the outlet to create a layer having a predetermined pattern.

2. The cup decoration device of claim 1, further comprising an actuator coupled to move the nozzle into and out of the cup.

3. The cup decoration device of claim 1, further comprising a housing coupled to the nozzle and configured to receive and store the ingredients, and wherein the pump comprises an air pump configured to apply an air pressure onto the ingredients to drive the ingredients through the outlet of the nozzle.

4. The cup decoration device of claim 1, wherein the pump is configured to directly pump the ingredients through the outlet of the nozzle.

5. The cup decoration device of claim 1, wherein the nozzle comprises an elongate, straight member having a slanted end defining the outlet, wherein the nozzle is configured to be positioned along a central axis of the cup.

6. The cup decoration device of claim 1, wherein the nozzle comprises an elongate, straight member, wherein the nozzle further includes a plurality of outlets including the outlet along a sidewall of the nozzle.

7. The cup decoration device of claim 1, wherein the nozzle comprises a deformable distal end portion defining the outlet, wherein the deformable distal end portion is configured to retain a shape imparted thereon.

8. The cup decoration device of claim 1, wherein the nozzle comprises an ellipsoid, and wherein the nozzle further includes a plurality of outlets including the outlet on the ellipsoid.

9. The cup decoration device of claim 1, wherein the motor is coupled to rotate the nozzle about a longitudinal axis of the nozzle.

10. The cup decoration device of claim 1, wherein the motor is coupled to rotate the nozzle about a rotation axis offset from a longitudinal axis of the nozzle.

11. The cup decoration device of claim 1, further comprising one or more actuators coupled to move the nozzle along one or more axes normal to a longitudinal axis of the nozzle.

12. The cup decoration device of claim 1, further comprising a sensor positioned on a distal end portion of the nozzle, wherein the sensor is configured to measure a distance between the nozzle and the inner surface of the cup.

13. A cup decoration device, comprising:
a nozzle coupled to receive ingredients, wherein the nozzle includes an outlet, and wherein the nozzle is configured to be positioned adjacent to or partially inside the cup;
a pump coupled to drive the ingredients through the outlet of the nozzle;
a motor coupled to rotate the cup relative to the nozzle; and
a controller operably coupled to the pump and the motor, wherein the controller is configured to operate the pump and the motor such that the nozzle dispenses the ingredients onto an inner surface of the cup via the outlet to create a layer having a predetermined pattern.

14. The cup decoration device of claim 13, wherein the nozzle is positioned offset from a central axis of the cup and adjacent to the inner surface of the cup, and wherein the motor is coupled to rotate the cup about the central axis of the cup.

15. The cup decoration device of claim 13, further comprising:
a housing coupled to the nozzle;
a stem coupled to the housing; and
a cup support coupled to the stem, the cup support comprising:
a platform configured to support the cup; and
a latch coupled between the stem and the platform, wherein the motor is coupled to rotate the platform about the latch.

16. The cup decoration device of claim 15, further comprising a linear actuator coupled to push on the cup support to rotate the platform about the latch.

17. The cup decoration device of claim 13, further comprising:
a housing coupled to the nozzle;
a stem coupled to the housing; and
a cup support coupled to the stem, the cup support comprising:
first and second arms positioned to circumferentially wrap around the cup; and
first and second rollers coupled to the first and second arms, respectively, wherein the first and second rollers are configured to contact the cup; and
a third roller positioned to contact the cup, wherein the motor is coupled to rotate the third roller to rotate the cup along the first and second rollers between the first and second arms.

18. A method for decorating a cup, comprising:
providing a nozzle configured to be positioned adjacent to or partially inside a cup;
driving ingredients through an outlet of the nozzle; and
moving one of the nozzle or the cup relative to the other such that the nozzle dispenses the ingredients onto an inner surface of the cup via the outlet to create a layer having a predetermined pattern.

19. The method of claim 18, further comprising measuring a distance between the nozzle and the inner surface of the cup, wherein moving the nozzle is based on the measured distance between the nozzle and the inner surface of the cup.

20. The method of claim 18, further comprising moving the other of the nozzle or the cup to create the layer having the predetermined pattern.

21. The method of claim 18, further comprising:
moving one of the nozzle or the cup relative to the other such that the nozzle is positioned adjacent to or partially inside the cup; and
driving the ingredients through the outlet such that the nozzle dispenses the ingredients onto a beverage prepared in the cup via the outlet.

22. A cup decoration device, comprising:
an ingredient container storing ingredients, wherein the ingredient container is pressurized;
a nozzle coupled to receive the ingredients from the ingredient container, wherein the nozzle includes one or more outlets;
a valve operably coupled between the ingredient container and the nozzle; and
a controller operably coupled to the nozzle, wherein the controller is configured to control the valve to control flow of the ingredients from the ingredient container to the nozzle such that the nozzle selectively dispenses the ingredients onto an inner surface of a cup positioned adjacent to the nozzle via the one or more outlets to create a layer of the ingredients thereon having a predetermined pattern.
